(19) United States
(12) Patent Application Publication
(10) Pub. No.: US 2015/0014098 A1
(43) Pub. Date: Jan. 15, 2015

(54) METHOD AND CONTROL DEVICE FOR MONITORING TRAVEL MOVEMENTS OF AN ELEVATOR CAR

(71) Applicant: Inventio AG, Hergiswil (CH)

(72) Inventors: Stefan Stölzl, Weinheim (DE); Thomas Schmidt, Schmitten (DE); Michael Degen, Bad Homburg (DE); Dominik Düchs, Mainz (DE); Frank Schreiner, Friedrichsdorf (DE); Erich Bütler, Ebikon (CH); Michael Geisshüsler, Luzern (CH); Nicolas Gremaud, Richterswil (CH)

(73) Assignee: Inventio AG, Hergiswil (CH)

(21) Appl. No.: 14/374,552

(22) PCT Filed: Jan. 24, 2013
(86) PCT No.: PCT/EP2013/051318

§ 371 Date: Jul. 25, 2014

(30) Foreign Application Priority Data
Jan. 25, 2012 (DE) 102012201086.6
Oct. 18, 2012 (EP) 12189011.5
Oct. 30, 2012 (EP) 12190499.9

(51) Int. Cl. B66B 5/00; B66B 1/32; B66B 1/30; B66B 5/04

(52) U.S. Cl. CPC B66B 5/0031; B66B 5/04; B66B 1/32; B66B 1/30
USPC 187/248; 187/394; 187/247

(57) ABSTRACT

A method and control device for monitoring travel movements of an elevator car utilize an electronic control device positioned at the car. Travel movements of the elevator car are travels, speeds or accelerations of the car. At least individual travel movements are subject to redundant detection for the purpose of monitoring. Either the travels or the speeds are redundantly detected and the accelerations singularly detected, or alternatively the accelerations are redundantly detected and the travels or the speeds are singularly detected, or preferably the travels or the speeds and the accelerations are redundantly detected. The electronic control device is preferably arranged at the support rollers of the elevator car.

### FIELD

The invention relates to a method of monitoring travel movements of an elevator car, to an electronic control device for monitoring travel movements of an elevator car and to an elevator car with a corresponding control device.

### BACKGROUND

Dynamically moved objects such as, in the present embodiment, travel bodies for elevator cars usually may not exceed predetermined accelerations and speeds for reasons of safety, since otherwise not only injuries to transported persons, but also damage of the moved object itself can no longer be excluded. Consequently, there is usually provided a control device which is adapted to the object and which recognizes excessive acceleration and appropriately reduces drive torque or activates a braking function in the case of excessive speeds.

In this connection, on the one hand mechanical devices which in the case of excessive speeds activate an emergency braking system are known from the prior art. Equally known are electronic control devices which on the basis of a detected acceleration sensor signal or speed sensor signal initiate a reduction in drive torque or a braking function. In that case, for reasons of safety two different physical sensor variables for weight or acceleration determination are often utilized. Moreover, it is known to additionally calculate acceleration by means of the speed sensor signal and, conversely, to additionally calculate a speed by means of the acceleration sensor signal.

It is significant with electronic control devices of that kind that recognition of exceeding of a safety-critical threshold value takes place sufficiently rapidly in order to be able to reliably initiate suitable counter-measures (for example, drive torque reduction or activation of a braking function) before onset of a risk of injury or damage. This is particularly important in the case of use in elevators, since in that regard, for example in the event of failure of support means, freefall conditions can arise which can lead to rapid increase in a speed of falling. Recognition of exceeding of the safety-critical threshold value is in that case often combined with a plausibility check of the sensor signals as well as with electrical monitoring actions.

Known plausibility checks of the acceleration sensor signal and speed sensor signal are in that case subject to disadvantage for the following reasons:

a. lengthy faulty recognition times and times for establishing plausibility due to preceding (model-based) recalculation of the acceleration sensor signal to form a speed signal or conversely,
b. high fault recognition thresholds and thus late initiation of necessary counter-measures in the case of excessive acceleration or excessive speed and
c. high levels of application outlay in the calibration of sensors as well as the (model-based) recalculation algorithms.

### SUMMARY

According to an inventive concept it is therefore proposed to use at least two acceleration sensor signals and at least one speed sensor signal or travel sensor signal simultaneously for plausibility checking. Alternatively, at least one acceleration sensor signal and at least two speed sensor signals or two travel sensor signals are used simultaneously for plausibility checking or in each instance at least two acceleration sensor signals and at least two speed sensor signals or travel sensor signals are used for plausibility checking. Thus, not only significantly rapid fault recognition of a sensor signal, but also significantly rapid initiation of a counter-measure are made possible in the case of recognition of excessive speed or excessive acceleration.

The movement variables used are preferably continuously subjected to a plausibility check and/or an error check. It is thus possible to create autonomously operating devices able to reliably monitor travel movements.

The respective sensor signals are preferably evaluated in an electronic control device (ECU). The ECU is in that case advantageously arranged at the dynamically moved object or elevator car.

The elevator car is usually supported by support means. For that purpose, the support means are guided over deflecting rollers arranged at the elevator car. A required supporting force in the support means can thus be reduced in correspondence with a loop suspension factor determined by an arrangement of the deflecting rollers. For preference, at least the speed sensors or travel sensors for detection of the speed sensor signals or the travel sensor signals are combined with these deflecting rollers or integrated therein. Due to the high support loading the deflecting rollers are securely driven by the support means and the corresponding speed sensor signals or travel sensor signals are correspondingly accurate and reliable.

The electronic control unit (ECU) or the processor unit thereof together with computing means for evaluation of the detected speed sensor signals or travel sensor signals is preferably similarly arranged in the immediate vicinity of the deflecting rollers. If need be, sensor components, for example, an incremental sensor for detection of incremental markings of the deflecting roller, are arranged directly on a circuitboard of the processor unit. For preference, an acceleration sensor or the redundant acceleration sensors for detection of the acceleration sensor signals can be similarly arranged on this circuitboard. An entire error and plausibility check can thus be undertaken at the location of the detection of the corresponding signals.

Preferably, in the case of an elevator car with several deflecting rollers, at least two deflecting rollers are equipped with an appropriate processor unit with computing means. Thus, not only individual measurement variables for fault and plausibility checking can be exchanged, but also results of the individual computing means can be compared.

The method according to the invention preferably comprises a first activation stage which enables reduction or adaptation of the drive torque of the dynamically moved object or the elevator car. For that purpose, use is advantageously made of two acceleration sensors, which are preferably constructionally integrated in the ECU as previously described. Monitoring of the two acceleration sensor signals a1 and a2 in that case is preferably carried out by means of, for example, comparison of the two acceleration sensor signals. If the two acceleration signals are substantially equal, then reliable values are present. Fundamentally, assessment can be based on the inequality |a1−a2|<ε. If the amount |a1−a2| lies above a predetermined threshold value c, then one of the two sensor signals is erroneous. As soon as an error of that kind is ascertained, then, for example, a warning signal is generated on the basis of which, for example, a check can be carried out. If, thereagainst, the amount |a1−a2| lies below the predetermined threshold value ε, then acceleration can be monitored by the acceleration sensor values reliably. If the measured acceleration exceeds a predetermined threshold value for the acceleration then safety information is effected on the basis of which, if need be, initially adaptation of the drive torque can take place. Depending on a state of loading and travel direction of the elevator car the adaptation can be a reduction or an increase of the drive torque. However, in many cases this adaptation or regulation of the drive torque is undertaken by an individual drive regulation associated with a drive of the elevator car, as a result of which this first activation stage can also be eliminated. Independently thereof obviously the measurement values of the sensor signals can be made available for drive regulation, shaft information or other travel information to the control of the elevator as a whole. Establishing plausibility of the acceleration signals with the speed signal or travel signal can be carried out as previously explained by direct comparison or also undertaken by means of recalculation of the other movement variables. This determination of plausibility in that case preferably serves for general monitoring of the sensor signals.

For preference, the at least two acceleration signals are evaluated directly and without preceding conversion or processing. Resulting from that is the advantage that a conclusion about a speed change of the dynamically moved object or the elevator car can be made with very fine sensitivity and rapidity since even a tendency towards high speed is recognized and the drive torque can be appropriately adapted in good time.

In the following, the elevator car is to be understood by the term “object”. An object movement is thus an elevator car movement or an object speed is an elevator car speed, etc.

A threshold value for acceleration, on the exceeding of which adaptation of the drive torque or switching-off of the drive torque takes place, is preferably predetermined in such a manner that a permissible maximum acceleration is exceeded beforehand. The measured acceleration thus has to lie above the permissible acceleration in order to reduce or switch off the drive torque.

Moreover, in the case of output of the safety information advantageously a second activation stage is provided which is preferably independent of the first activation stage. The second activation stage activates at least one braking device (for example, an emergency braking system) and/or switches off the drive torque. This advantageously takes place on the basis of an excessive actual speed v, optionally additionally combined with at least one excessive actual acceleration a1 or a2. Checking of the sensor signals and establishing plausibility thereof in that case preferably takes place as described in the foregoing.

The already-described monitoring of acceleration with respect to exceeding of a threshold acceleration makes it possible to recognize a multiplicity of faulty operating conditions, but not all faulty operating conditions. In particular, accelerations lying below the threshold acceleration can equally lead to safety-critical exceedings of the threshold speed. Such exceedings of the threshold speed can be recognized by monitoring a speed value.

For example, as speed value use is made of the speed calculated from the acceleration sensor signal according to

Va=F(a1,a2),

wherein F is a suitably selected computing rule of the time-dependent accelerations a1, or a1 and a2. For preference, F is an integral rule. Resulting from that is the advantage that the first and second activation stages are based on the same sensor signal (advantageously acceleration) and as a result the measures to be initiated in accordance with the first activation stage and the second activation stage correspond. Determination of plausibility and thus monitoring of the speed value obtained from the acceleration sensors are undertaken by the speed sensor signal V preferably by way of the relationship

βVa−V|<ε1.

Alternatively, determination of plausibility and thus monitoring of the speed value obtained from the acceleration sensors can also take place with the travel sensor signal s. In that case, the speed sensor signal V is preferably calculated from the travel sensor signal s by way of a differentiation rule D as follows

V=D(s),

and determination of plausibility and thus monitoring of the speed value obtained from the acceleration sensors by the travel sensor signal s thus preferably takes place by way of the relationship

|Va−V|<ε1 or |Va−D(s)|<ε1.

If the threshold value ε1 is exceeded, then the sensor signals are no longer plausible and the system must, in the case of emergency, be directly transferred to a safe state.

The speed sensor signal or the travel sensor signal thus preferably has the task of monitoring the speed signal calculated from the acceleration sensor signals. Through recalculation of the acceleration sensor signals to form the speed signal and the continuous recalculation, if required, of the travel sensor signals to form the speed signal it is possible to perform a direct speed comparison. Through filtering of the signals and (model-based) recalculation of the signal values it is, however, possible here—by comparison with monitored based purely on an acceleration sensor—for a delay in time to occur. Rapid changes of movement are thus reliably detected by monitoring the acceleration value and slow changes in movement can be detected by monitoring the speed value.

If, through monitoring of the threshold value ε for the threshold acceleration, faulty behavior of the sensors is apparent then by use of three sensors (two acceleration sensors and one speed sensor or one travel sensor) it is nevertheless possible to maintain an error tolerance. In that case in addition preferably the following recalculation is carried out:

Va1=F(a1) and Va2=F(a2)

Advantageously, distinction can be made between the following cases:
1) If Va1 and V lie in a predetermined tolerance band, whereagainst Va2 and V lie outside the predetermined tolerance band, then a2 is erroneous.
2) If Va2 and V lie in a predetermined tolerance band, whereagainst Va1 and V lie outside the predetermined tolerance band, then a1 is erroneous.
3) If a1 and a2 lie in a predetermined tolerance band, whereagainst Va1 and V as well as Va2 and V lie outside the predetermined tolerance band, then V is erroneous.

This differentiation of case is preferably carried out when errors based on common causes (so called common-cause error) of the sensors present in redundant form can be excluded. If this is not excluded, for example a1 and a2 could derive from unrecognized common departures from an initial calibration value within a predetermined tolerance band, but Va1 and V as well as Va2 and V respectively lie outside the predetermined tolerance band. In this case not V, but a1 and a2 would erroneous. Therefore, error system algorithms known per se are preferably executed in order to recognize a common-cause fault of (any) two of the three sensors or use is made of different sensor manufacturers in order to exclude errors based on common causes.

An error processing of that kind or of the relevant category makes it possible, notwithstanding a recognized fault, to still maintain basic functionality up to the end of a maintenance period appropriate to the respective case of use. As a result, improved diagnosis can be carried out (for example, whether a speed sensor or an acceleration sensor has to be exchanged). Determination of a faulty sensor can, for example, trigger a maintenance request.

Moreover, it is possible and preferred to use speed sensor signals in order to calculate an acceleration signal. In this case, preferably a differentiating rule for calculation of the acceleration signal from the speed sensor signal is used instead of an integral rule. The described processing and use of the speed signals and the acceleration signals is appropriately interchanged.

For preference, instead of fixed threshold values operation can also be with dynamic threshold values. The threshold values are in this case dependent on the respective operating conditions of the object such as, for example, the speed of the object or also a distance of the object from an obstacle or an end of a travel path.

Moreover, it is preferred if the sensors prior to use thereof are subjected to a calibration method, which is known per se, on a single occasion, at defined intervals in time during the use thereof, irregularly or as needed. In addition, a self-regulating calibrating process is possible and preferred. Equally, any combinations of the stated calibrating processes are possible and preferred.

For preference, mutual monitoring of all sensors used is carried out.

The safety device according to the invention is in addition preferably employed for cases of use in which in general a minimum acceleration or minimum speed is required, so that in the event of the minimum acceleration or the minimum speed not being maintained suitable safety measures can be similarly initiated.

### DESCRIPTION OF THE DRAWINGS

Further preferred forms of embodiment are evident from the following description of embodiments on the basis of figures, in which:

FIG. 1 shows a schematic construction of a safety device.

FIG. 2 shows a first exemplifying sequence of the method for monitoring travel movements of an elevator car.

FIG. 3 shows a further exemplifying sequence of the method for monitoring travel movements of an elevator car.

FIG. 4 shows a schematic view of an elevator car with a safety device.

Equivalent parts and functions are provided with the same reference numerals.

### DETAILED DESCRIPTION

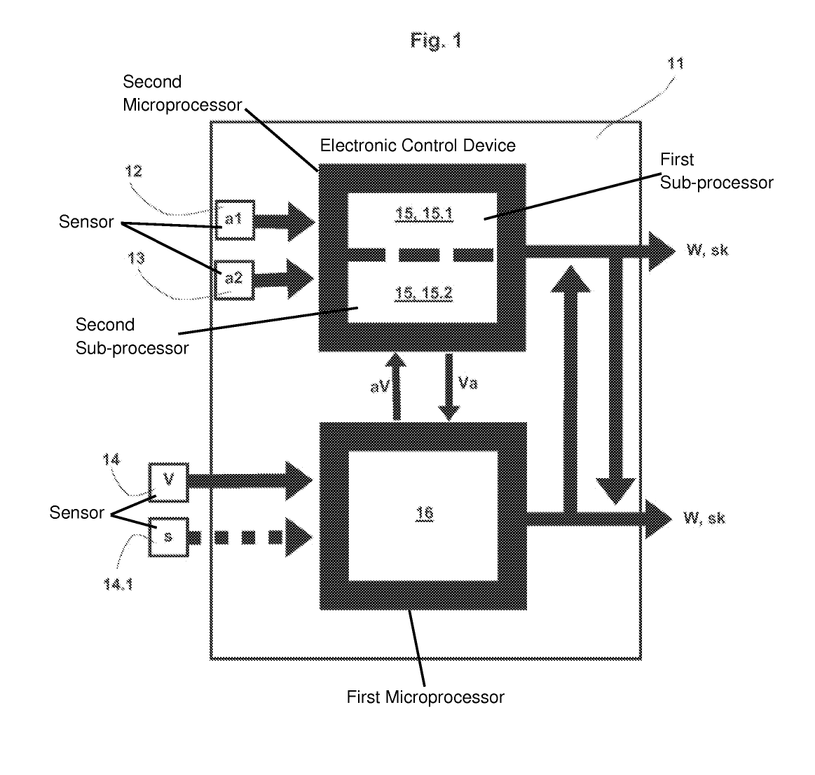

An electronic control device 11 (ECU 11) comprising acceleration sensors 12 and 13 as well as a speed sensor 14 or a travel sensor 14.1 is illustrated in FIG. 1. The ECU 11 is part of the electronic regulating system of an electrically operated travel body, or elevator car. The acceleration sensors 12 and 13 are arranged directly in the ECU 11, whereas the speed sensor 14 or the travel sensor 14.1 is arranged outside the ECU 11 and only a speed sensor signal V or a travel signal s is passed on to a first microprocessor 16 in the ECU 11. If required, the first microprocessor 16 calculates the speed sensor signal V from the travel signal s.

A second microprocessor 15 obtains the acceleration sensor signals a1 and a2 from the acceleration sensors 12 and 13 and checks these for plausibility. At the same time, the second microprocessor 15 calculates a speed Va from the acceleration sensor signals a1 and a2 by means of an integral rule and executes a fault system algorithm in order to recognize possible common-cause faults of the acceleration sensors a1 and a2.

The speed Va is output to the first microprocessor 16, which compares the speed Va with the speed V and thus checks for plausibility. Moreover, the first microprocessor 16 calculates an acceleration aV by means of a differentiating rule and passes on the acceleration aV to the second microprocessor 15. The second microprocessor 15 now compares the acceleration aV with the acceleration sensor signals a1 and a2 for plausibility. If as a consequence of the plausibility analysis a faulty sensor is recognized, a corresponding warning signal W can be generated or the elevator car can be stopped, for example after the conclusion of a travel cycle.

Moreover, the second microprocessor 15 and the first microprocessor 16 constantly compare the acceleration values aV, a1 and a2 as well as the speed values V and Va with predetermined threshold values. The second microprocessor 15 compares the values a1, a2 and aV with predetermined threshold values, whereas the first microprocessor 16 compares the values Va and V with predetermined threshold values.

If one of the values aV, a1, a2, V or Va exceeds a predetermined threshold value and a sensor fault is excluded or an erroneous signal cannot be identified free of doubt, an item of safety information sk for reducing the drive torque or for introducing a braking process is output from that microprocessor which has ascertained exceeding of the threshold value.

Exceeding of the threshold value usually has the consequence in a first activation stage of reduction of the drive torque or of a controlled stopping of the elevator car, whereas exceeding of the threshold value in a second activation stage leads to initiation of a braking process.

If need be, the second microprocessor 15 is subdivided into a first sub-processor 15.1 and a second sub-processor 15.2, so that evaluation and comparison in connection with one acceleration sensor 12 is undertaken by the first sub-processor 15.1 and evaluation and comparison in connection with the other acceleration sensor 13 is undertaken by the second sub-processor 15.2. As a result, possible faults in the region of the processors can be recognized.

In that case, the second microprocessor 15 preferably processes sensor output data of at least one acceleration sensor 12, 13 and the first microprocessor 16 evaluates sensor output data of at least one speed sensor 14 or travel sensor 14.1.

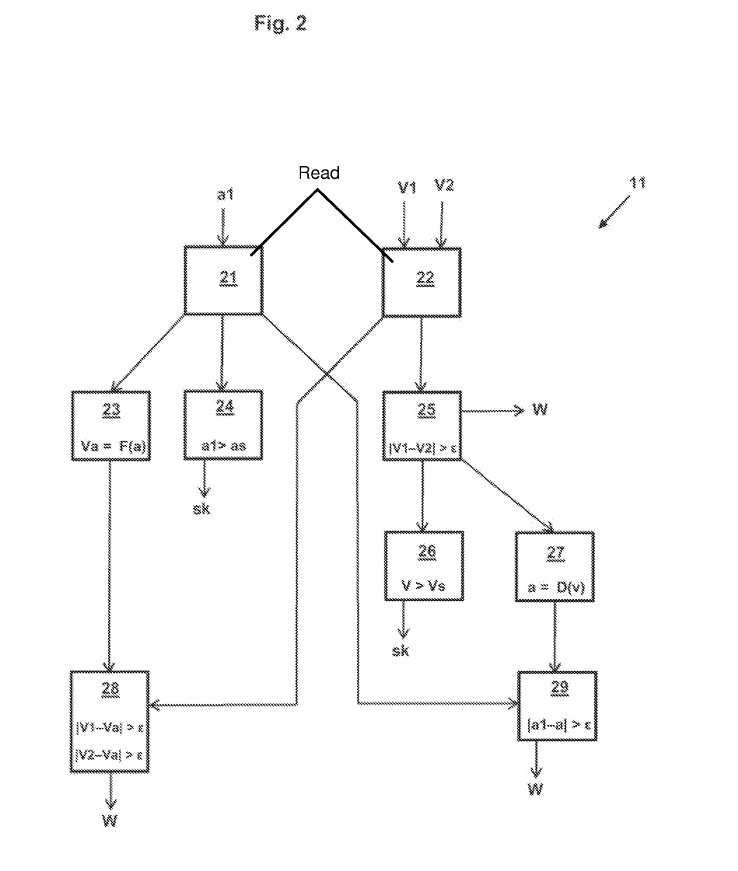

A possible sequence, in the form of a flow chart, of a method can be seen in FIG. 2. The acceleration value a1 is read in method step 21. In dependence thereon at the same time two speed values V1 and V2 are read in method step 22. A comparison of the acceleration value a1 with a predetermined threshold value as for the acceleration takes place in step 24. If the acceleration value a1 exceeds the predetermined threshold value as for the acceleration a corresponding item of safety information sk is output and accordingly the drive torque, which causes the acceleration, is reduced or a braking process is initiated. Insofar as the acceleration value a1 does not exceed the predetermined threshold value for acceleration, no further reaction takes place in step 24. Simultaneously, with step 24, the acceleration value a1 is recalculated in step 23 by means of an integral function to form the speed value Va. Determination of plausibility and error checking of the read-in speed values V1 and V2 takes place in method step 25. Insofar as the speed values V1 and V2 are plausible and no error is recognized, the process is continued in steps 26 and 27. Otherwise, for example, the warning signal W is issued.

A comparison of speed values V1 and V2 with a threshold value Vs for the speed is undertaken in method step 26. If at least one of the speed values V1 and V2 exceeds the predetermined threshold value Vs for the speed, the item of safety information sk is output and accordingly the drive torque, which drives the elevator car, is adapted or a braking process is initiated. To the extent that neither of the speed values V1 and V2 exceeds the predetermined threshold value for the speed, there is no further reaction. At the same time, speed values V1 or V2 are recalculated in step 27 by means of a differentiating rule to form a mean acceleration a. Finally, determination of plausibility and error checking of the speed values V1 and V2, which have been read in step 22, with the speed value Va calculated in step 23 are carried out in method step 28. Parallel thereto determination of plausibility and error checking of the acceleration value a1 read-in in step 21 and of the acceleration value a calculated in step 27 are undertaken in step 29. Insofar as implausibility or an error is recognized in one of steps 28 and 29 an appropriate warning signal W is issued and the elevator car is stopped immediately or after the conclusion of the travel cycle.

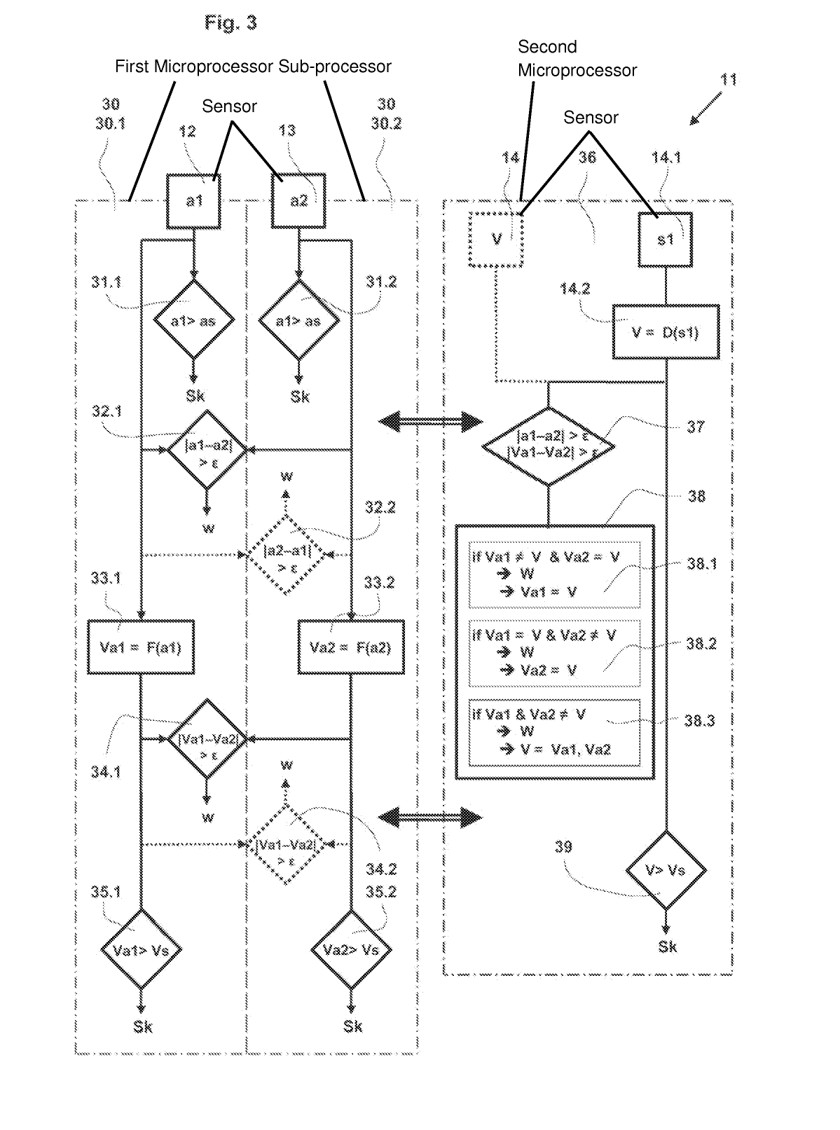

An alternative or supplementing variant of a possible sequence of a method is illustrated in FIG. 3. The ECU 11 consists of a first microprocessor 30 and a second microprocessor 36. The acceleration sensors 12 and 13 are associated with the first microprocessor 30 and the speed sensor 14 or the travel sensor 14.1 is associated with the second microprocessor 36.

The acceleration sensor signals a1 and a2 of the two acceleration sensors 12 and 13 are compared with an acceleration threshold value as in a first step 31.1, 31.2 in the first microprocessor 30. Insofar as one of the two acceleration sensor signals exceeds the threshold value, thus a1 or a2> (is greater than) as, the item of safety information Sk is output and accordingly the drive torque, which drives the elevator car, is adapted or a braking process is initiated.

Determination of plausibility and error checking of the read-in acceleration sensor signals a1 and a2 are carried out in a further step 32.1, 32.2. Insofar as the acceleration signals a1 and a2 are plausible, i.e. if a difference of the two values lies below an error threshold value ε and thus no error is recognized, a status signal is set to OK. Otherwise, the warning signal W is issued. Thus, for example, servicing is required or, depending on further, later-described assessments, the elevator installation continues in operation, is stopped or continues in operation only in a reduced mode.

In another step 33.1, 33.2 the acceleration sensor signals a1 and a2 are recalculated by means of an integral function, Va1,2=F(a1, 2), into speed values Va1 or Va2 and these calculated speed values Va1 and Va2 are compared with one another in step 34.1, 34.2. Insofar as a difference of the two acceleration sensor signals a1 and a2 lies below an error threshold value E, the status signal is set to OK. Otherwise, the warning signal W is issued. The error threshold value ε is obviously referred in each instance to the values to be compared, such as speed, acceleration, etc.

In addition, in a next step 35.1, 35.2 the speed values Va1 and Va2 are compared with a speed threshold value Vs. Insofar as one of the two speed values exceeds the speed threshold value Vs, thus Va1 or Va2> (is greater than) Vs, the item of safety information Sk is issued.

The first microprocessor 30 is preferably divided into two sub-processors 30.1 and 30.2, wherein the two acceleration sensors 12 and 13 are shared out to the two sub-processors 30.1, 30.2. The two sub-processors can perform the comparison and calculation steps in parallel, whereby possible processor faults can be recognized. Determination of plausibility and error checking in the steps 32.1, 32.2 and 34.1, 34.2 can be similarly carried out with reciprocal redundancy in the two sub-processors 30.1, 30.2 or they can be carried out by one of the sub-processors.

The speed sensor signal V of the speed sensor 14 is ascertained or detected in the second processor 36. In an alternative (illustrated in dashed lines) a speed value V is detected by means of, for example, a tachogenerator. For preference, however, use is made of a travel sensor 14.1 which detects, for example by means of travel increments, a travel difference s1 from which the speed value V is derived or ascertained by means of a calculation routine 14.2.

Moreover, in a checking step 39 the speed value V is compared with a speed threshold value Vs. Insofar as the speed value V exceeds the threshold value, thus V> (is greater than) Vs, the item of safety information Sk is output.

Moreover, in a comparison step 37 it is checked on the one hand whether the status signals of the plausibility determination and error check steps 32.1, 32.2, 34.1, 34.2 are set to OK by the first microprocessor or whether a warning signal W was issued. In addition, the speed value V is compared with the speed values Va1 and Va2 calculated by the first microprocessor 30. Insofar as a difference of the respectively calculated speed values Va1 and Va2 from the speed value V lies below an error threshold value ε, the status signal is set to OK. Otherwise, the warning signal W is issued.

If it is now established in a comparison step 37 that all status signals of the plausibility determination and error checking steps 32.1, 32.2, 34.1, 34.2 and 37 are set to OK, operation of the monitoring device or the electronic control device 11 is continued. Otherwise, a further error analysis 38 is started.

If in accordance with step 38.1 of the error analysis 38 the speed values Va2 and V lie in the predetermined tolerance band, whereagainst Va1 and V lie outside the predetermined tolerance band then it can be established that the acceleration sensor signal a1 or the associated calculation routine is faulty.

If in accordance with step 38.2 the speed values Va1 and V lie in the predetermined tolerance band, whereagainst Va2 and V lie outside the predetermined tolerance band then it can be established that the acceleration sensor signal a2 or the associated calculation routine is faulty.

If, however, in accordance with step 38.3 the acceleration sensor signals a1 and a2 lie in the predetermined tolerance band, but the speed comparison values Va2 to V and Va1 to V thereagainst lie outside the predetermined tolerance band then it can be established that the speed signal V or possibly the associated calculation routine is faulty.

Thus, the faulty signal can be selectively ascertained and a service engineer can quickly replace the component concerned. During an operating time up to exchange of the component the faulty signal can be suppressed or temporarily replaced by one of the two intact signals.

Preferred procedures for monitoring object travels s, s1, s2, object speeds V, V1, V2 and object accelerations a, a1, a2 are thus distinguished in dependence on the illustrated embodiments in that:

1) At least the object travels s, s1, s2, the object speeds V, V1, V2 or at least the object accelerations a, a1, a2 are redundantly detected.

2) The object travels s, s1, s2 are detected redundantly and the object accelerations a, a1, a2 are detected singularly or

the object speeds V, V1, V2 are detected redundantly and the object accelerations a, a1, a2 are detected singularly or

the object accelerations a, a1, a2 are detected redundantly and the object speeds V, V1, V2 or the object travels s, s1, s2 are detected singularly.

3) The object travels s, s1, s2 and/or the object speeds V, V1, V2 and/or the object accelerations a, a1, a2 are subject to a plausibility check and/or an error check.

4) The object travels s, s1, s2 or the object speeds V, V1, V2 or the object accelerations a, a1, a2 are recognized as plausible if the condition |a1−a2|<ε or |V1−V2|<ε1 or |s1−s2|<ε2 is fulfilled, wherein ε, ε1 and ε2 are maximum amounts of a permissible difference.

5) The error check is carried out by means of error system algorithms, which compare the behavior of the redundantly detected object travels s, s1, s2, object speeds V, V1, V2 or the redundantly detected object accelerations a, a1, a2 with one another or the calculated equivalent values thereof with one another.

6) Object speeds V, V1, V2 and/or object travels s, s1, s2 are calculated from the object accelerations a, a1, a2 by means of integral rules.

7) Object speeds V, V1, V2 and/or object accelerations a, a1, a2 are calculated from the object travels s, s1, s2 by means of a differentiating rule.

8) The object accelerations a, a1, a2 are compared in a first activation stage with a threshold value for the acceleration and, in the case of exceeding the threshold value for the acceleration, adaptation and/or shutting-off of the drive torque is undertaken or a braking function is activated.

9) The object speeds V, V1, V2 are compared in a second activation stage with a threshold value for the speed and, in the case of exceeding of the threshold value for the speed, adaptation and/or shutting-off of the drive torque is undertaken or a braking function is activated.

10) The object speeds V, V1, V2 are calculated in the second activation stage from the object accelerations a, a1, a2.

11) The object accelerations a, a1, a2 are detected by means of acceleration sensor signals.

12) The object speeds V, V1, V2 are detected by means of speed sensor signals, for example by tachogenerators, and/or the object travels s, s1, s2 are detected by means of travel signals, such as by incremental sensors or encoders.

13) The acceleration sensor signals and/or the speed sensor signals and/or the travels are directly evaluated without preceding processing and/or filtering and/or recalculation.

14) The threshold value for the object accelerations a, a1, a2 lies above an object-dependent permissible maximum acceleration and the threshold value for the object speeds V, V1, V2 lies above an object-dependent permissible maximum speed.

15) The acceleration signals are detected by means of acceleration sensors and/or the speed sensor signals are detected by means of speed sensors and/or the travel sensor signals are detected by means of travel sensors.

16) The acceleration sensors, the speed sensors and/or the travel sensors are calibrated on one occasion or repeatedly.

17) The acceleration sensor signals are subject to plausibility determination by means of speed sensor signals in that an object speed calculated from the object accelerations a, a1, a2 is compared with the speed detected by means of the speed sensors or with the speed calculated from the travel sensor signals.

18) A mutual plausibility determination of all speed sensors or travel sensors and acceleration sensors which are present is undertaken.

19) Tolerance bands are used for the error checking, wherein errors due to positioning of the object accelerations a, a1, a2 and/or the object speeds V, V1, V2 and/or the object travels s, s1, s2 within and/or outside the tolerance bands are recognized.

20) The tolerance bands predetermined for the error check are used only when faulty functioning of redundantly present sensors can be excluded.

Preferred electronic control devices 11 for monitoring object speeds V, V1, V2 and object accelerations a, a1, a2 comprise, for example, a second electronic computing means 15 or corresponding first processors 30, which carry out evaluation of sensor output information and in dependence on the result of the sensor output information evaluation initiate reduction of a drive torque and/or shutting off of the drive torque and/or activation of a braking device, wherein the control device 11 executes a process like in the preceding examples 1 to 20 or a combination of these examples.

It preferably further comprises a first electronic computing means 16 or second processor 36, which exchanges data with the first computing means or processor. In that case, the first computing means 16 or the second processor 36 preferably similarly executes evaluation of sensor output information and in dependence on the result of the sensor output information evaluation it initiates reduction of the drive torque and/or shutting-off of the drive moment and/or activation of the braking device.

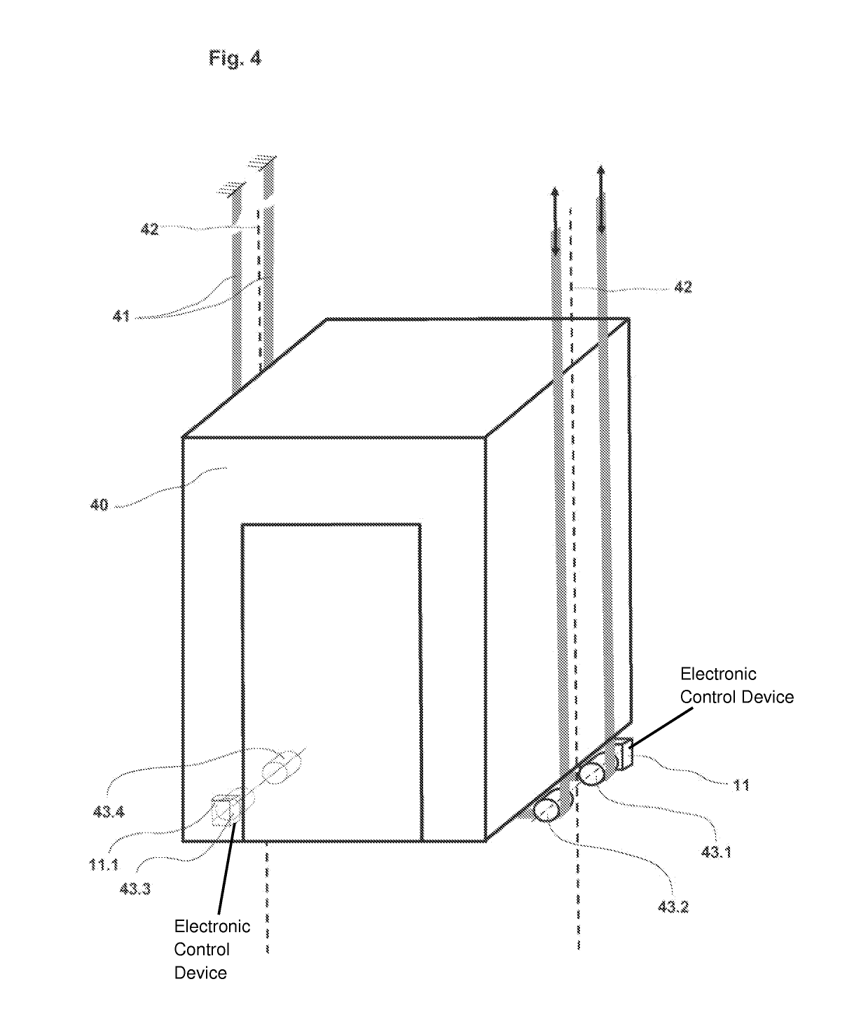

As illustrated in FIG. 4, the electronic control device (ECU) 11 is installed in an elevator installation, preferably at the elevator car 40, in order to monitor travel movements thereof. In the example the elevator car is supported and moved by way of support means 41. The support means 41 are fixedly suspended at one end, for example fastened in a building structure (not illustrated). At the other end they are movable by a drive means, which is indicated by double arrows in FIG. 4. The support means are led through under the elevator car 40, in which case they are deflected by support rollers 43.1, 43.2, 43.3, 43.4. The elevator car is guided by means of guide rails 42. In the example, a respective support means is arranged on both sides of a guide plane determined by the guide rails 42. A symmetrical supporting of the elevator car 40 is thereby made possible. Obviously a required number of support means 41 results from a required load to be supported and constructional execution of the elevator system. In the example, the electronic control device (ECU) 11 is associated with one of the support rollers 43.1, i.e. an incremental transmitter for detection of the travel s of the elevator car is derived directly from a rotational movement of the support roller 43.1. The ECU 11 is constructed as explained in the preceding examples. Thus, the travel movements of the elevator car 40 can be monitored reliably and optimally in terms of costs. Driving of the support rollers is ensured by the high supporting force transmitted to the car by means of the support roller. In addition, obviously a further ECU 11.1 or at least individual ones of the redundant sensors can be arranged at another support roller 43.3 preferably not driven by the same support means (illustrated in dashed lines in FIG. 4). Thus, reliability can be further increased since, for example, an individual support means becoming slack can lead to disturbance of movement at the corresponding support roller, which can be recognized by the supplementing comparison routines. These comparison routines can be integrated in one of the ECU 11 or ECU 11.1 or a supplementary comparison box can be provided.

The at least one acceleration sensor 12, 13 is preferably constructionally integrated in a housing of the control device 11. Sharing out of the sensors to individual microprocessors and sub-processors can be selected by the expert.

In accordance with the provisions of the patent statutes, the present invention has been described in what is considered to represent its preferred embodiment. However, it should be noted that the invention can be practiced otherwise than as specifically illustrated and described without departing from its spirit or scope.

1-14. (canceled)

15. A method of monitoring travel movements of an elevator car, wherein travels, speeds and accelerations represent the travel movements of the elevator car, comprising the steps of:
detecting values of the accelerations redundantly;
detecting values of the travels or the speeds singularly or redundantly; and
checking the detected values for at least one of plausibility, error and exceeding a threshold value, and indicating the at least one of the plausibility, the error and the exceeding a threshold value of the detected values.

16. The method according to claim 15 including continuously checking the detected travel values or the detected speed values, and the redundantly detected acceleration values for the at least one of the plausibility, the error and the exceeding a threshold value.

17. The method according to claim 15 including comparing the redundantly detected acceleration values in a first activation stage with a threshold value for acceleration and, if the acceleration threshold value is exceeded, initiating at least one of adaptation and shutting-off of a drive torque applied to the elevator car, or activating a braking function to brake the elevator car.

18. The method according to claim 17 including comparing the detected speed values or calculated speed values in a second activation stage with a threshold value for speed and, if the speed threshold value is exceeded, initiating at least one of adaptation and shutting-off of the drive torque, or activating the braking function, wherein the calculated speed values are calculated from the detected acceleration values by an integral rule, or are calculated from the detected travel values by a differentiating rule.

19. The method according to claim 18 wherein at least one of the acceleration threshold value and the speed threshold value is a dynamic threshold value, wherein the dynamic threshold value is dependent on operating conditions of the elevator car.

20. A method of monitoring travel movements of an elevator car, wherein travels, speeds and accelerations represent the travel movements of the elevator car, comprising the steps of:
detecting values of at least one of the travels, the speeds and the accelerations redundantly, wherein
the travel values or the speed values are detected redundantly and the acceleration values are detected singularly, or
the acceleration values are detected redundantly and the travel values or the speed values are detected singularly, or
the travel values or the speed values are detected redundantly and the acceleration values are detected redundantly;
executing an error check with error system algorithms comparing behavior of the redundantly detected travel values, speed values or acceleration values with one another or comparing calculated equivalent values thereof with one another; and
indicating at least one of plausibility and error of the checked values.

21. The method according to claim 20 including calculating:
at least one of the calculated speed values and the calculated travel values from the detected acceleration values by means an integral rule, and/or
at least one of the calculated speed values and the acceleration values from the detected travel values by a differentiating rule, and/or
the calculated acceleration values from the detected speed values by the differentiating rule.

22. The method according to claim 20 including performing the plausibility check by comparing the redundantly detected travel values or the redundantly detected or calculated speed values, or the redundantly detected acceleration values and recognizing the detected values as plausible when a difference between the compared values is less than a predetermined maximum amount of difference.

23. The method according to claim 20 including performing the plausibility check of the detected acceleration values by: comparing a speed value calculated from the detected acceleration values with the detected speed values; or comparing the speed value calculated from the detected acceleration values with another speed value calculated from the detected travel values.

24. The method according to claim 20 including comparing the acceleration values in a first activation stage with a threshold value for the acceleration and, if the acceleration threshold value is exceeded, initiating at least one of adaptation and shutting-off of a drive torque applied to the elevator car, or activating a braking function to brake the elevator car.

25. The method according to claim 24 including comparing the detected or calculated speed values in a second activation stage with a threshold value for the speed and, if the speed threshold value is exceeded, initiating at least one of adaptation and shutting-off of the drive torque, or activating the braking function.

26. An electronic control device for monitoring the travel movements of the elevator car according to the method of claim 20 comprising a first electronic computing means or processor for performing evaluation of sensor output information representing the detected values and in dependence on a result of the sensor output information evaluation initiates at least one of adaptation of a drive torque or shutting-off of the drive torque applied to the elevator car, or activation of a braking device of the elevator car.

27. An electronic control device for monitoring the travel movements of the elevator car according to the method of claim 15 comprising a first electronic computing means or processor for performing evaluation of sensor output information representing the detected values and in dependence on a result of the sensor output information evaluation initiates at least one of adaptation of a drive torque or shutting-off of the drive torque applied to the elevator car, or activation of a braking device of the elevator car.

28. The electronic control device according to claim 27 wherein the control device is mounted on the elevator car and activates the braking device that is arranged at the elevator car.

29. The electronic control device according to claim 27 including a second electronic computing means or processor which exchanges items of information with the first electronic computing means or processor, wherein the second electronic computing means or processor performs evaluation of the sensor output information and in dependence on a result of the sensor output information evaluation initiates at least one of adaptation of the drive torque and discontinuation of the drive torque, or activation of the braking device.

30. The electronic control device according to claim 27 including at least one acceleration sensor is constructionally integrated in a housing of the control device for detecting the acceleration values.

31. An elevator car having a braking device and a control device according to claim 27, wherein the elevator car includes at least one deflecting roller and at least one first support supporting the elevator car by the first deflecting roller, and wherein the first deflecting roller includes or drives a first speed sensor for generating the detected speed values as a first speed sensor signal to the control device or a first travel sensor for generating the detected travel values as a first travel sensor signal to the control device.

32. The elevator car according to claim 31 wherein the first speed sensor is a tachogenerator and the first travel sensor is an incremental sensor.

33. The elevator car according to claim 31 wherein the elevator car includes at least a second deflecting roller and the first support or a second support conjunctively supports the elevator car by the second deflecting roller, and wherein the second deflecting roller includes or drives a second speed sensor for generating the detected speed values as a second speed sensor signal to the control device or another control device, or includes or drives a second travel sensor for generating the detected travel values as a second travel sensor signal to the control device or another control device.

34. The elevator car according to claim 33 wherein the second speed sensor is a tachogenerator and the second travel sensor is an incremental sensor.

35. The elevator car according to claim 33 wherein the first speed sensor or the first travel sensor is connected with the first computing means or processor, the second speed sensor or the second travel sensor is connected with the second computing means or processor, and first and second acceleration sensors for detection of the detected acceleration values are connected with the second computing means or processor.
